(19) United States
(12) Patent Application Publication
(10) Pub. No.: US 2007/0042754 A1
(43) Pub. Date: Feb. 22, 2007

(54) Security parameter provisioning in an open platform using 3G security infrastructure

(76) Inventors: Sundeep M. Bajikar, Santa Clara, CA (US); Francis X. McKeen, Portland, OR (US); Selim Aissi, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/193,139

(22) Filed: Jul. 29, 2005

(51) Int. Cl. H04M 1/66

(52) U.S. Cl. 455/411

(57) ABSTRACT

A method and system for provisioning a shared secret key to enable trusted communications between a SIM and a platform running a trusted application in a third generation or beyond wireless network.

### BACKGROUND

Embodiments of the present invention relate to trusted computer platforms, and more specifically to security parameter provisioning for trusted platforms within a 3rd Generation (3G) network.

The 3GPP Technical Specification 33.220 V6.0.0 provides for a generic bootstrapping architecture (GBA). The GBA infrastructure may be used to enable application functions in the network and on the user side to establish shared keys. Thus, a 3GPP operator can provide bootstrapping of application security to authenticate the subscriber.

A network model for bootstrapping is illustrated in FIG. 1. The Home Subscriber System (HSS) (102) interfaces with the Bootstrapping Server function (BSF) (104) via the Zh interface. The BSF (104) and the User Equipment (UE) (106) interface via the Ub interface.

The Network Application Function (NAF) represents a generic network application function which may provide one or more applications or services to the User Equipment (UE) (106). The UE may include Mobile Equipment (ME), Terminal Equipment (TE), and a Subscriber Identity Module (SIM).

The BSF (104) and the NAF (108) interface via the Zn interface. Finally, the NAF (108) and the UE (106) interface via the Ua interface.

The requirements for each network element and each interface are set forth in the 3GPP Technical Specification 33.220 V6.0.0.

As mobile computing becomes more prevalent, there is a need for providing a secure, 3GPP compliant interface between secure applications running on a platform and a Subscriber Identity Module (SIM) or a UMTS Subscriber Identity Module (USIM).

### BRIEF DESCRIPTION OF THE DRAWINGS

A better understanding of the present invention can be obtained from the following detailed description in conjunction with the following drawings, in which:

FIG. 1 is an illustration of a simple network model for bootstrapping using the 3GPP Generic Bootstrapping Architecture.

FIG. 2 is an illustration of a system block diagram for platform shared secret key provisioning according to one embodiment.

FIG. 3 is a flow diagram illustrating generation of a platform shared secret key according to one embodiment.

FIG. 4 is a flow diagram illustrating generation of a platform shared secret key according to one embodiment.

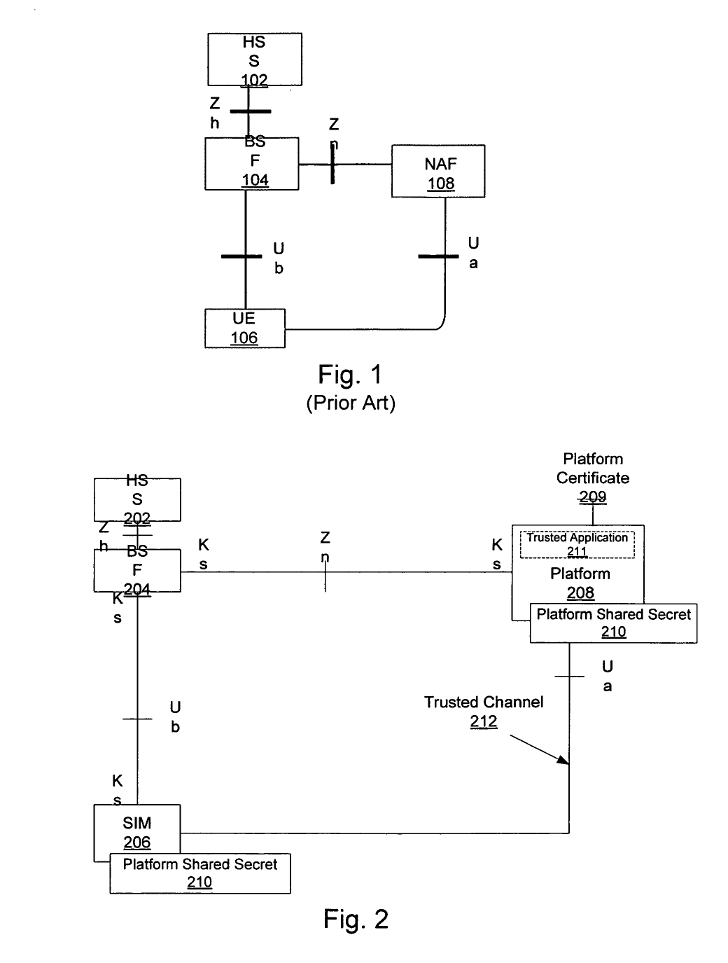

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern security parameter provisioning for 3G networks. Although the following discussion centers on 3G networks, it will be understood by those skilled in the art that the present invention as hereinafter claimed may be practiced in support of any type of network having similar protocol requirements. For example, embodiments of the present invention may be used with future network protocols including B-3G (beyond-3G) networks. Embodiments may also be applies to any network/capabilities built on top of 3G or beyond networks, including S3G, High-Speed Downlink Packet Access (HSPDA), and others.

Reference throughout this specification to “one embodiment” or “an embodiment” indicates that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

FIG. 2 illustrates a system block diagram for platform shared secret key provisioning according to one embodiment. Provisioning will initialize the necessary security parameters to enable a trusted channel between a trusted platform running a trusted application and a SIM (or USIM). In one embodiment, the trusted channel is enabled by provisioning of a platform shared secret between the SIM and the platform through an operator's 3G security infrastructure.

A system may include a Home Subscriber System (HSS) (202), a Bootstrapping Server Function (BSF) (204), a computing device or platform (208), and a SIM (206), which may be a Universal Mobile Telecommunications System (UMTS) SIM (USIM).

The Home Subscriber System (HSS) (202) interfaces with the Bootstrapping Server function (BSF) (204) via the Zh interface.

The BSF (204) is communicatively coupled to the SIM (206) through the Ub interface. This interface may be a wired or wireless interface. The Ub interface is defined by the 3GPP Generic Bootstrapping Architecture (GBA) Specification. The BSF (204) and the SIM (206) run the 3GPP GBA protocol to generate a shared key, Ks. The shared key, Ks, is sent from the BSF to the SIM. The SIM uses the shared key, Ks to generate a platform shared secret key (210), which is used to ensure security on the Ua interface, thus enabling a trusted channel (212) between the SIM (206) and the platform (208).

The platform (208) may be a substitute for a Network Application Function (NAF), or may augment a NAF. In one embodiment, the platform may be a mobile computing device, such as a notebook computer, a handheld device, or a mobile telephone.

The platform may include a platform certificate (209), which contains information including but not limited to the manufacturer of the platform, the generation and stepping of microprocessor used in the platform, and the generation and stepping of the chipset used in the platform.

A trusted application (211) may run on the platform. In one embodiment, the platform may utilize Intel Corporation's LaGrande Technology (LT) to provide a secure environment for the trusted application.

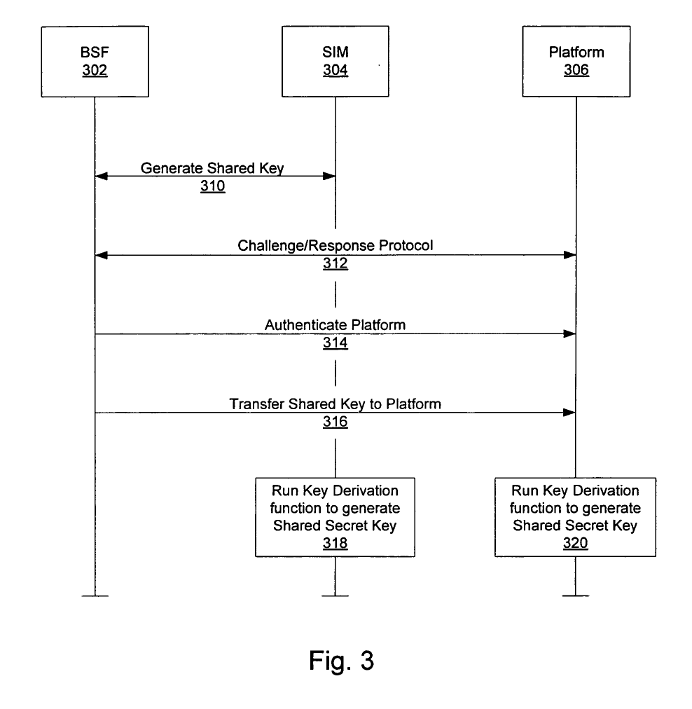

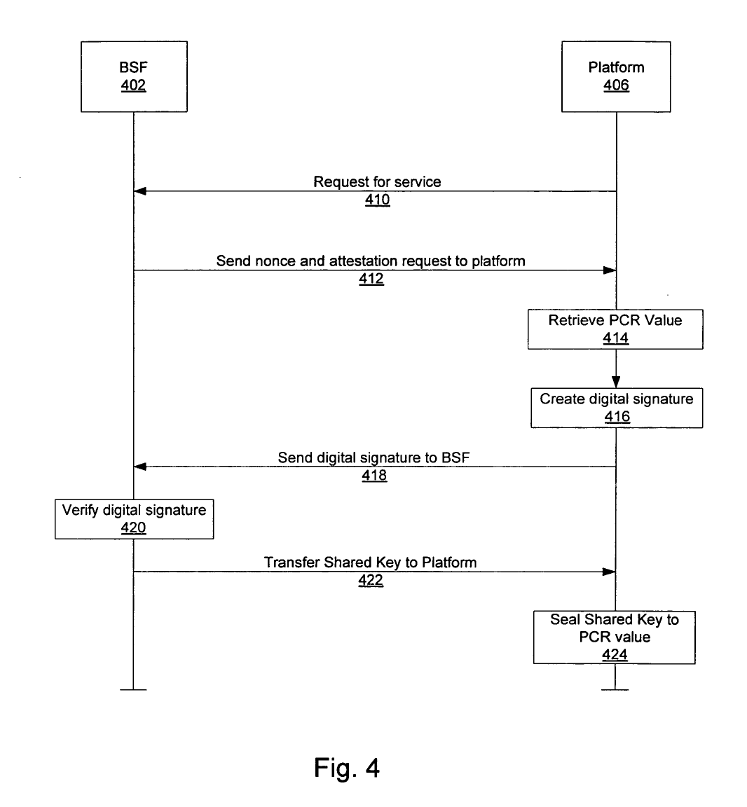

The BSF (204) interfaces with the platform (208) or with a trusted application running on the platform (211) via the Zn interface. The Zn interface is typically an operator-specific or proprietary protocol. The Zn interface may allow a generic NAF, such as a trusted application (211) running on a platform, to fetch the key agreed to by the BSF (204) during a previous GBA protocol transfer over the Ub interface between the BSF (204) and the SIM (206). Thus, the platform may receive the shared key, Ks, from the BSF (204) over the Zn interface. The transfer of Ks over the Zn interface is described in more detail below, in conjunction with FIGS. 3 and 4.

After the platform (208) receives the shared key, Ks, from the BSF (204), the platform generates a platform shared secret key (210). The platform shared secret key generated by the platform and the SIM are the same, and are used to secure the Ua interface, thus enabling a trusted channel (212) between the SIM (206) and the platform (208).

FIG. 3 illustrates provisioning of a shared secret key to a SIM (304) and a platform (306) by a BSF (302).

First, the BSF (302) and the SIM (304) run the 3GPP GBA protocol to generate a shared key (310) at both the BSF and the SIM.

Next, the BSF (302) runs a challenge/response protocol (312) with a trusted application running on a platform (306). The challenge/response protocol may be a proprietary protocol determined by a mobile network operator (MNO). The challenge/response protocol is used to determine the trustworthiness of the trusted application prior to authentication of the platform. In one embodiment, the platform may be a mobile computer, such as a notebook. The platform may be a secure platform, for example, an Intel® notebook computer with LaGrande Technology, which is running a trusted application.

After successful completion of the challenge/response protocol (312), the BSF authenticates the platform (314) and determines the trustworthiness of the platform's hardware and software environment. In one embodiment, the trustworthiness may be checked using the LaGrande Technology (LT) attestation process, which is described in detail below in conjunction with FIG. 4.

When the platform has been authenticated by the BSF, the BSF transfers the shared key to the platform (316). The shared key is sealed to the platform's hardware and software environment that was deemed trustworthy by the BSF during the authentication process (314).

Finally, after both the SIM (304) and the platform (306) have received a shared key from the BSF, the SIM runs a key derivation function to generate a platform shared secret key (318) and the platform runs a key derivation function to generate a platform shared secret key (320). The platform shared secret key derived by the SIM and by the platform is used to ensure trusted communications over the Ua interface between the platform or a trusted application on the platform and the SIM.

FIG. 4 illustrates details of the attestation process between the BSF (402) and the platform (406) for provisioning of the shared key, Ks, via the Zn interface. The platform provides information to the BSF regarding the current environment. The BSF then uses that information to make a trust decision before provisioning the shared secret. The trust decision takes into account the hardware, software, and configuration options currently executing on the platform. The BSF is interested in these items because certain combinations may have exploitable security holes. The BSF must be able to rely on the platform, and must avoid any exploitable security holes.

The BSF needs both static and dynamic information from the platform. Static information may include, but is not limited to, the manufacturer of the platform, the specific generation and stepping of the processor, and the specific generation and stepping of the chipset. Dynamic information may include, but is not limited to, the specific identity of a loaded virtual machine monitor (VMM), the specific identity of a loaded secure transfer monitor (STM), the specific identity of a Basic I/O System (BIOS) module, or other software, monitors, or modules that the BSF wants the platform to attest to.

The static information may be provided in the form of a platform certificate provided by the platform original equipment manufacturer (OEM). The dynamic information may gathered and reported each time an attestation request is received. The goal of the attestation process is for the BSF to be able to receive and verify the static and dynamic information in order to make a trust decision about provisioning the shared key into the platform.

To begin the attestation process, the platform (406) requests service (410) from the mobile network operator (MNO). The service request is routed to the MNO's BSF (402).

Upon receiving a service request, the BSF creates a nonce, which is used to prevent replay attacks, and sends the nonce and a request for attestation (412) to the platform.

When the platform receives the attestation request, it internally generates the necessary commands to gather the static and dynamic information required by the BSF for attestation. In one embodiment, the platform may generate trusted platform module (TPM) commands to retrieve the current platform configuration register (PCR) value (414).

The trusted platform module then creates a digital signature of the current PCR value (416). This digital signature may include the nonce received from the BSF. A private key may be used to provide the digital signature, and may be bound to the platform certificate, an attestation identity key (AIK), or other credentials, to protect privacy.

After the digital signature is created, it is sent from the platform to the BSF (418). The BSF verifies the digital signature (420), validates the nonce, and evaluates the information from the PCR provided in the digital signature to determine if the platform is trustworthy. In one embodiment, determining whether the platform is trustworthy may include comparing a PCR value to a list or database containing one or more known good PCR values.

If the platform is deemed trustworthy (e.g. if the PCR value from the platform matches a known good PCR value), then the BSF transfers the shared key to the platform (422).

The platform may seal the shared key to the PCR value (424). This ensures that each time the shared key is accessed within the notebook, the original environment represented by the PCR to which the shared key was sealed must be present. Thus, the shared key will no longer be valid if the PCR value changes.

Thus, a method, apparatus, and system for provisioning a platform shared secret key to enable a trusted channel between an application running on a platform and a SIM are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
authenticating a subscriber identity module (SIM) over a network;
generating a platform secret key for the SIM;
transferring the platform secret key to the SIM;
authenticating a platform running a trusted application using attestation; and
transferring the platform secret key to the platform.

2. The method of claim 1, wherein the network is a third generation (3G) wireless network.

3. The method of claim 1, wherein the SIM is a Universal Mobile Telecommunications System (UMTS) SIM.

4. The method of claim 1, wherein authenticating the platform running the trusted application using attestation comprises receiving a service request from the platform, creating a nonce, sending the nonce and a request for attestation to the platform, receiving a digital signature including platform information from the platform, and determining whether the platform is trustworthy based on the digital signature.

5. The method of claim 4, wherein determining whether the platform is trustworthy based on the digital signature comprises comparing a platform configuration register value within the digital signature to a list of one or more known good platform configuration register values.

6. The method of claim 1, further comprising sealing the platform secret key to the platform.

7. A method comprising:
receiving a nonce and an attestation request from a mobile network operator over a network;
creating a digital signature including a platform configuration register value and the nonce;
sending the digital signature to the mobile network operator;
receiving a platform secret key from the mobile network operator; and
generating a platform shared secret key from the platform secret key.

8. The method of claim 7, wherein the network is a third generation (3G) wireless network.

9. The method of claim 7, further comprising sending a service request to a mobile network operator before receiving the nonce and attestation request from the mobile network operator.

10. The method of claim 9, further comprising sealing the platform secret key to the platform.

11. The method of claim 7, wherein the platform configuration register value includes dynamic information.

12. The method of claim 11, wherein the platform configuration register value further includes static information.

13. A system comprising:
a platform to run a trusted application, to receive a first shared key from a bootstrapping server function, and to generate a first shared secret key using the first shared key; and
a subscriber identity module (SIM) communicatively coupled to the platform to receive a second shared key from the bootstrapping server function and to generate a second shared secret key using the second shared key, wherein the first shared secret key and the second shared secret key are identical and enable trusted communication between the platform and the SIM.

14. The system of claim 13, wherein the platform is a mobile platform.

15. The system of claim 14, wherein the platform is a notebook computer.

16. The system of claim 13, wherein the platform is a device that has been authenticated by the bootstrapping server function.

17. The system of claim 13, wherein the SIM is a Universal Mobile Telecommunications System (UMTS) SIM.

18. An article of manufacture comprising a machine-accessible medium having stored thereon instructions which, when executed by a machine, cause the machine to:
authenticate a UMTS subscriber identity module (USIM) over a wireless network;
generate a platform secret key for the USIM;
transfer the platform secret key to the USIM;
run a challenge/response protocol with a platform running a trusted application;
authenticate the platform running the trusted application using attestation; and
transfer the platform secret key to the platform running the trusted application.

19. The article of manufacture of claim 18, wherein the instructions, when executed by the machine, further cause the machine to seal the platform secret key to the platform.

20. The article of manufacture of claim 18, wherein the wireless network is a third generation wireless network.
